(19) United States
(12) Patent Application Publication
(10) Pub. No.: US 2018/0181101 A1
(43) Pub. Date: Jun. 28, 2018

(54) NUMERICAL CONTROLLER

(71) Applicant: Fanuc Corporation, Minamitsuru-gun (JP)

(72) Inventor: Takafumi Sasaki, Minamitsuru-gun (JP)

(73) Assignee: Fanuc Corporation, Minamitsuru-gun (JP)

(21) Appl. No.: 15/845,542

(22) Filed: Dec. 18, 2017

(30) Foreign Application Priority Data
Dec. 22, 2016 (JP) 2016-249676

(51) Int. Cl. G05B 19/19; G05B 19/404; G05B 19/18; G05B 19/408

(52) U.S. Cl. CPC G05B 19/19; G05B 19/404; G05B 2219/35; G05B 19/4083; G05B 19/182

(57) ABSTRACT

A numerical controller of the present invention includes a command analyzing unit configured to read out and analyze a block from a program and generate moving command data on the basis of the analysis result, an interpolating unit configured to generate interpolation data by performing interpolation processing on the basis of the moving command data, a servo control unit configured to control each axis on the basis of the interpolation data, a path displacement determining unit configured to calculate a distance between a program command path commanded by the program and a tool tip point of the tool after a moving amount of each axis in this control period on the basis of the moving command data, the interpolation data and a current position of each axis and determines whether or not the calculated distance is equal to or greater than an acceptable amount defined in advance, and an alerting unit configured to output an alert in the case where the distance is determined that it is equal to or greater than the acceptable amount defined in advance.

### BACKGROUND OF THE INVENTION

### 1. Field of the Invention

The present invention relates to a numerical controller, and more particularly, to a numerical controller which detects displacement of a moving path of a tool.

### 2. Description of the Related Art

In a five-axis machining tool, a control point path is obtained for a commanded tool tip path while rotation of a tool and rotation of a table are taken into account. By making a motor operate on the control point path, a tool tip of an actual machine eventually operates on the commanded path (for example, Japanese Patent Laid-Open No. 2003-196917, or the like). While there exists a numerical controller for obtaining a tool tip path from a control point path (for example, Japanese Patent Laid-Open No. 2011-43874), this tool is directed to verification after machining is finished, and is not directed to preventing erroneous operation during machining.

There is a case where, during automatic operation of work machining using a five-axis machining tool, automatic operation is interrupted and the operation is switched to manual operation by an operator to change a tool or confirm a status of machining. While it is necessary for the operator to move a tool from a position when automatic operation is interrupted by manual operation to change the tool or confirm the status of machining, there is a problem that, when the operator moves a tip of the tool to an erroneous position after the operator accomplishes the purpose (without restoring the tip of the tool to the original position after manual operation) and restarts machining, an actual tool tip position deviates from the commanded path, which causes erroneous cutting or machine interference.

### SUMMARY OF THE INVENTION

As illustrated in FIG. 1, the present invention solves the above-described problem by providing to a numerical controller a function of obtaining a tool tip position by performing calculation inverse to normal calculation on the basis of a rotation axis position and a machine tool length, with respect to a control point position which is to be output by the numerical controller, calculating a distance between the obtained tool tip position and a program command path, and, in the case where the calculated distance differs by equal to or greater than an acceptable amount, issuing an alarm without outputting a movement pulse to the control point position to stop automatic operation. By this monitoring being constantly performed during machining, the numerical controller of the present invention can prevent erroneous cutting and machine interference which are caused by an unexpected problem.

The numerical controller of the present invention controls a five-axis machining tool which drives a tool tip point of a tool which performs machining on a workpiece attached on a table, using axes including three straight axes and two rotation axes, on the basis of a program, includes a command analyzing unit configured to read out and analyze a block of the program and output a moving command data generated on the basis of the analysis result, an interpolating unit configured to generate interpolation data by performing interpolation processing on the basis of the moving command data and output the generated interpolation data, a servo control unit configured to control the axes on the basis of the interpolation data, a path displacement determining unit configured to calculate a distance between a program command path commanded by the program and a tool tip point of the tool after moving amounts of the axes in this control period are added on the basis of the moving command data, the interpolation data and current positions of the axes and determine whether or not the calculated distance is equal to or greater than an acceptable amount defined in advance, and an alerting unit configured to output alert in the case where the path displacement determining unit determines that the distance is equal to or greater than the acceptable amount defined in advance.

According to the present invention, by displacement of the path being constantly monitored during machining, it is possible to prevent erroneous cutting and machine interference which are caused by an unexpected problem.

### BRIEF DESCRIPTION OF THE DRAWINGS

The above-described and other objects and characteristics of the present invention will become apparent from the following description of an embodiment with reference to the following accompanying drawings:

FIG. 1 is a diagram illustrating a case where a tool tip point is displaced from a program command path;

FIG. 2 is a diagram explaining displacement of a path of the tool tip point which is assumed in the present invention;

FIG. 3 is a figure (1) explaining a method for calculating a distance between the program command path and the tool tip point;

FIG. 4 is a figure (2) explaining a method for calculating a distance between the program command path and the tool tip point;

FIG. 5 is a figure (3) explaining a method for calculating a distance between the program command path and the tool tip point;

FIG. 6 is a schematic hardware configuration diagram of a numerical controller according to an embodiment of the present invention; and

FIG. 7 is a schematic functional block diagram of the numerical controller according to an embodiment of the present invention.

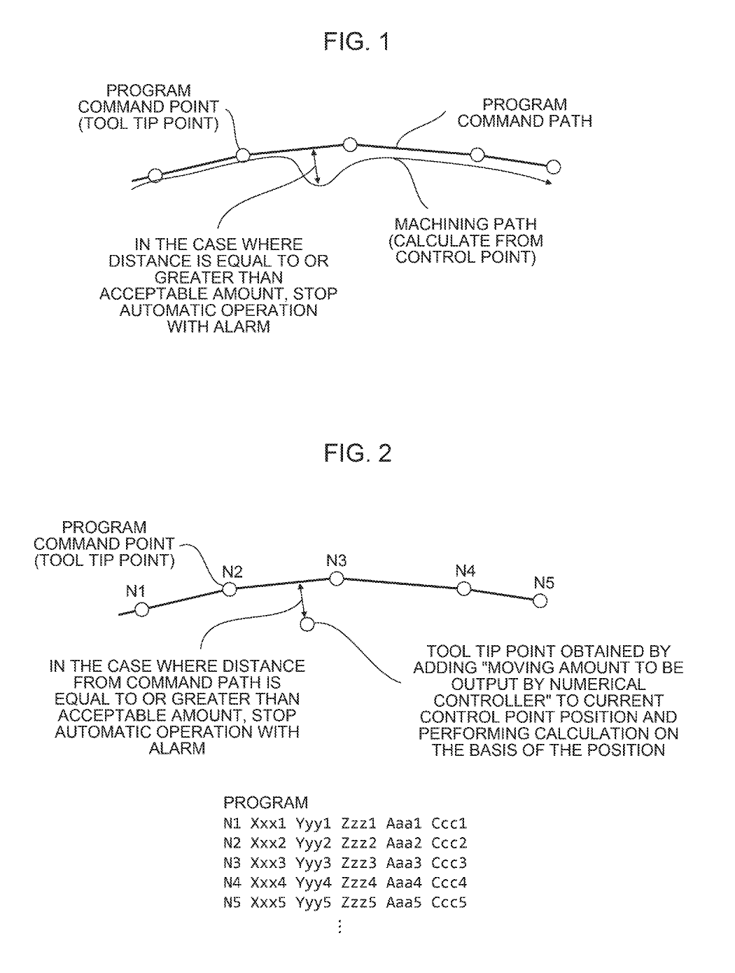

### DETAILED DESCRIPTION OF THE PREFERRED EMBODIMENTS

An embodiment of the present invention will be described below along with the drawings. Outline of a path displacement detecting function of the present invention will be described first using FIG. 2 to FIG. 5.

FIG. 2 is a diagram explaining displacement of a path of a tool tip point which is assumed in the present invention. Note that, to simplify the description, FIG. 2 illustrates a program command path between respective program command points with straight line. In the present invention, a numerical controller which controls a five-axis machining tool disclosed in Japanese Patent Laid-Open No. 2003-195917, Japanese Patent Laid-Open No. 2011-43874, or the like, is assumed. A numerical controller of the present invention issues an alarm to stop automatic operation without adding moving amounts to respective axes (outputting a movement pulse) in the case where, when a tool tip point is moved to a program command point commanded by each block of a program which is being executed, a point of moving destination to which the tool tip point is to be moved in a control period of this time is away from the program command point by an amount equal to or greater than an acceptable amount defined in advance.

In the example of FIG. 2, an example is illustrated in the case where an operator interrupts automatic operation and performs manual operation during execution of an N2 block when automatic operation is performed in accordance with a program illustrated in a lower part of FIG. 2, and the operator moves a tip of a tool to an erroneous position after the manual operation and restarts automatic operation. At this time, the numerical controller of the present invention calculates a distance between a program command path drawn by the tool tip point according to a command of the N2 block if automatic operation were continued to be performed, and a position of the tool tip point obtained on the basis of a position of a control point in the case where moving amounts to be added to respective axes in a control period of this time are added to a current position of the control point, and, in the case where the calculated distance is equal to or greater than a predetermined acceptable value defined in advance, issues an alarm without adding the moving amounts to the respective axes (outputting a movement pulse) and stops automatic operation.

The numerical controller of the present invention calculates a distance between the program command path and the position of the tool tip point T in each of three cases.

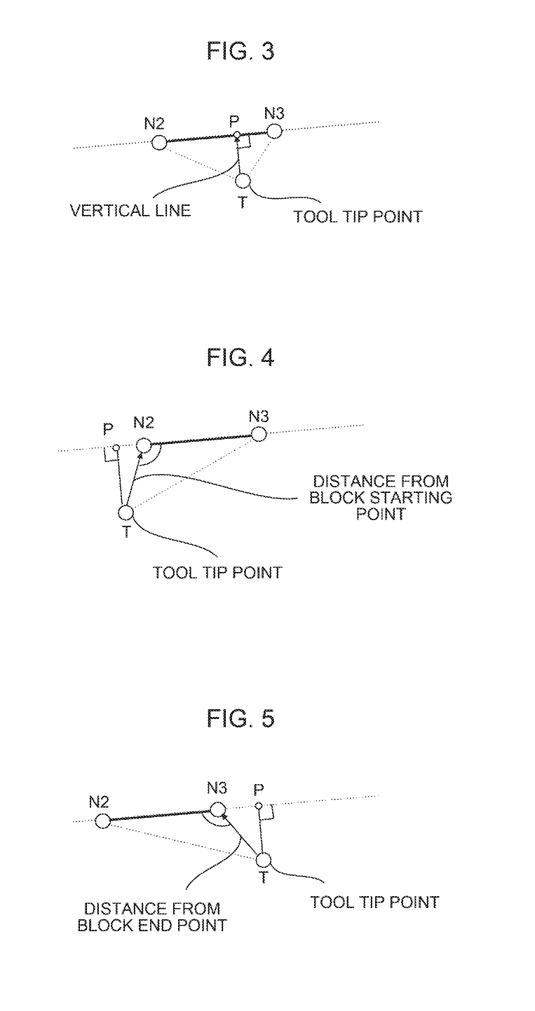

FIG. 3 is a diagram illustrating a method for calculating a distance between the program command path and the position of the tool tip point T in the case where an intersection point P of a straight line including the program command path by a block which is executed when automatic operation is interrupted and a vertical line with respect to the straight line from the position of the tool tip point T is located between a starting point and an end point of the program command path. In a case of positional relationship as illustrated in FIG. 3, the numerical controller of the present invention sets a distance between the tool point T and the intersection point P of the program command path by the block which is executed when automatic operation is interrupted from the position of the tool tip point T and the vertical line to the program command path, as a distance between the program command path and the position of the tool tip point T.

FIG. 4 is a diagram illustrating a method for calculating a distance between the program command path and the position of the tool tip point T in the case where the intersection point P of the straight line including the program command path by the block which is executed when automatic operation is interrupted and the vertical line with respect to the straight line from the position of the tool tip point T is located beyond the starting point of the program command path when seen from the end point of the program command path. In a case of positional relationship as illustrated in FIG. 4, the numerical controller of the present invention sets a distance between the tool tip point T and the starting point of the program command path as the distance between the program command path and the position of the tool tip point T.

FIG. 5 is a diagram illustrating a method for calculating a distance between the program command path and the position of the tool tip point T in the case where the intersection point P of the straight line including the program command path by the block which is executed when automatic operation is interrupted and the vertical line with respect to the straight line from the position of the tool tip point T is located beyond the end point of the program command path when seen from the starting point of the program command path. In a case of positional relationship as illustrated in FIG. 5, the numerical controller of the present invention sets a distance between the tool tip point T and the end point of the program command path as the distance between the program command path and the position of the tool tip point T.

A configuration of the numerical controller according to an embodiment of the present invention will be described below.

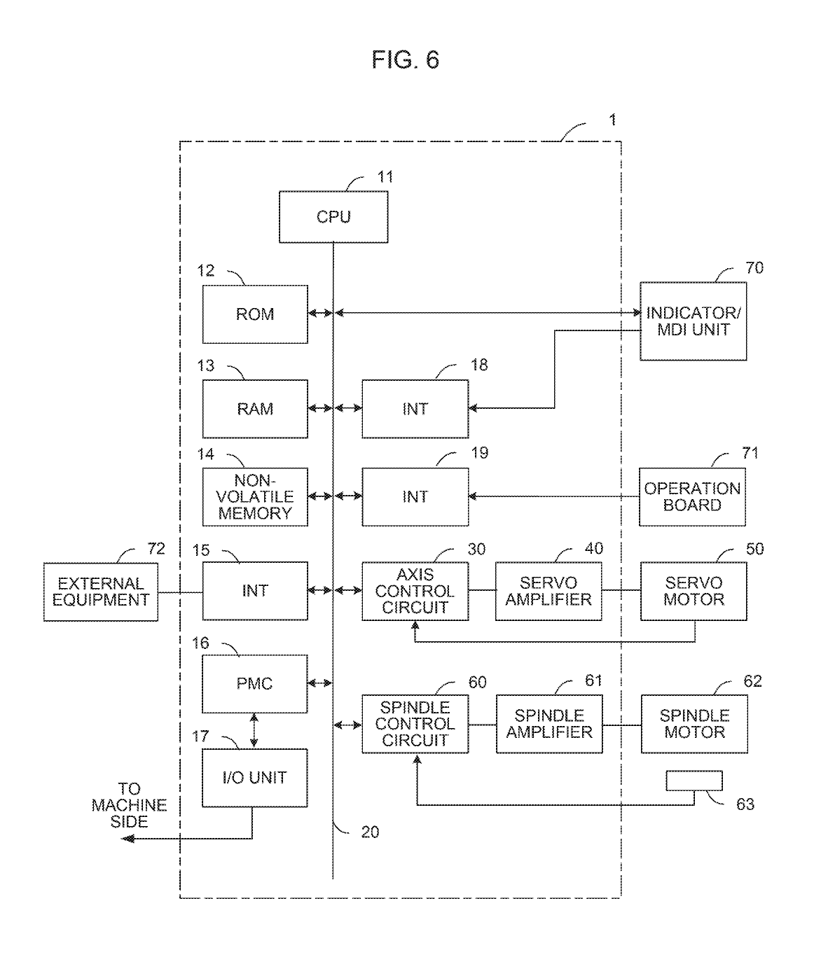

FIG. 6 is a hardware configuration diagram illustrating main parts of the numerical controller according to an embodiment of the present invention and a machining tool which is driven and controlled by the numerical controller. A CPU 11 provided at the numerical controller 1 is a processor which wholly controls the numerical controller 1. The CPU 11 reads out a system program stored in a ROM 12 via a bus 20 and controls the whole numerical controller 1 in accordance with the system program. In a RAM 13, temporal calculation data, display data, various kinds of data input by the operator through an indicator/MDI unit 70 which will be described later, or the like, are stored.

A non-volatile memory 14 is configured as a memory in which a storage state is maintained even if the numerical controller 1 is powered down, by, for example, a power source being backed up with a battery which is not illustrated. In the non-volatile memory 14, a machining program loaded via an interface 15 and a machining program input via an indicator/MDI unit 70 which will be described later are stored. While, in the non-volatile memory 14, a program for machining program operation processing to be used for operating the machining program, or the like, is further stored, these programs are expanded in the RAM 13 upon execution. Further, in the ROM 12, various kinds of system programs for executing processing of an editing mode which is required for creating and editing the machining programs are written in advance.

The interface 15 is an interface for connecting the numerical controller 1 and external equipment 72 such as an adapter. The machining programs, various kinds of parameters, or the like, are loaded from the external equipment 72 side. Further, the machining program edited within the numerical controller 1 can be stored in external storage means via the external equipment 72. A PMC (programmable machine controller) 16 performs control by outputting signals to peripheral apparatuses (for example, an actuator such as a robot hand for changing a tool) of the machining tool via an I/O unit 17 using a sequence program incorporated in the numerical controller 1. Further, the PMC 16 receives signals from various kinds of switches and the like on an operation board disposed on the body of the machining tool, performs necessary signal processing and passes the signals to the CPU 11.

The indicator/MDI unit 70 is a manual data input apparatus including a display, a keyboard, or the like, and the interface 18 receives a command and data from the keyboard of the indicator/MDI unit 70 and passes the command and data to the CPU 11. An interface 19 is connected to an operation board 71 including a manual pulse generator, or the like.

An axis control circuit 30 for controlling axes provided at the machining tool receives a commanded amount of movement of axes from the CPU 11 and outputs the command for the axes to a servo amplifier 40. The servo amplifier 40 which receives this command drives a servo motor 50 which moves the axes provided at the machining tool. The servo motor 50 of the axes has a built-in position and speed detector, feeds back a position and speed feedback signal from the position and speed detector to the axis control circuit 30 and performs feedback control of the position and the speed. Note that, while in the hardware configuration diagram in FIG. 6, only one axis control circuit 30, one servo amplifier 40 and one servo motor 50 are illustrated, actually, they are provided corresponding to the number of axes provided at the machining tool. For example, in a case of a five-axis machining tool, axis control circuits 30, service amplifiers 40 and servo motors 50 corresponding to three straight axes (X axis, Y axis and Z axis) and two rotation axes (A axis and C axis) are provided.

A spindle control circuit 60 receives a principal axis rotation command to the machining tool and outputs a spindle speed signal to a spindle amplifier 61. The spindle amplifier 61 which receives this spindle speed signal, rotates a spindle motor 62 of the machining tool at a commanded rotation speed to drive the tool.

A position coder 63 is coupled to the spindle motor 62, and the position coder 63 outputs a feedback pulse in synchronization with rotation of the principal axis, and the feedback pulse is read by the CPU 11.

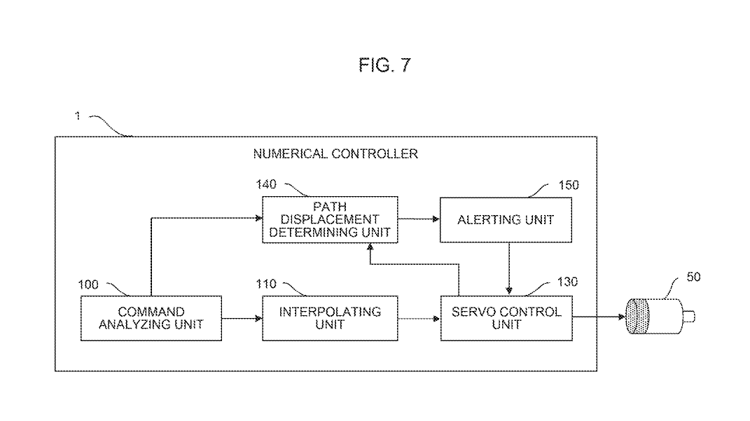

FIG. 7 is a schematic functional block diagram of the numerical controller according to an embodiment of the present invention in which a system program for realizing the path displacement detecting function described above is implemented at the numerical controller 1 illustrated in FIG. 6. Each functional block illustrated in FIG. 7 is realized by the CPU 11 provided at the numerical controller 1 illustrated in FIG. 6 executing the system program of the path displacement detecting function and controlling operation of each unit of the numerical controller 1. The numerical controller 1 of the present embodiment includes a command analyzing unit 100, an interpolating unit 110, a servo control unit 130, a path displacement determining unit 140 and an alerting unit 150.

The command analyzing unit 100 analyzes a block of machining commands included in the program read out from a memory which is not illustrated to generate data relating to a moving command, and outputs the generated data relating to the moving command to the interpolating unit 110 and the path displacement determining unit 140.

The interpolating unit 110 generates interpolation data calculated by interpolating points on a commanded path commanded by the data relating to the moving command with a control period on the basis of the data relating to the moving command accepted from the command analyzing unit 100 and outputs the generated interpolation data (an amount of movement of each axis of each control period) to the servo control unit 130.

The servo control unit 130 then controls the servo motor 50 which controls each axis to be controlled on the basis of the output of the interpolating unit 110.

The path displacement determining unit 140 obtains a program command path commanded by each block on the basis of the data relating to the moving command analyzed by the command analyzing unit 100, executes the above-described processing on the basis of the interpolation data (an amount of movement of each axis of each control period) input from the interpolating unit 110 to the servo control unit 130 and a current position of each axis held by the servo control unit 130 on the basis of feedback, or the like, from the servo motor 50, calculates a distance between a program command path which is currently being executed and a position of a tool tip point after a moving amount of this control period is added to each axis, and determines whether or not the calculated distance is equal to or greater than an acceptable amount δ defined in advance. In the case where the distance between the program command path which is currently being executed and the position of the tool tip point after the moving amount of this control circuit is added to each axis is equal to or greater than the acceptable amount δ defined in advance, the path displacement determining unit 140 commands output of an alert to the alerting unit 150.

When the alerting unit 150 receives a command to output an alert from the path displacement determining unit 140, the alerting unit 150 commands the servo control unit 130 to stop addition of the moving amount of each axis after this control period (output of a movement pulse), and notifies the operator of the alert by, for example, sound, light or display at an indicator of the indicator/MDI unit 70.

While the embodiment of the present invention has been described above, the present invention is not limited to only the example of the above-described embodiment and can be implemented in various forms by making changes as appropriate.

1. A numerical controller which controls a five-axis machining tool which drives a tool tip point of a tool for performing machining on a workpiece attached to a table using axes including three straight axes and two rotation axes, on the basis of a program, the numerical controller comprising:
a command analyzing unit configured to read out and analyze a block of the program and output moving command data generated on the basis of the analysis result;
an interpolating unit configured to generate interpolation data by performing interpolation processing on the basis of the moving command data and output the generated interpolation data;
a servo control unit configured to control the axes on the basis of the interpolation data;
a path displacement determining unit configured to calculate a distance between a program command path commanded by the program and the tool tip point of the tool after moving amounts of the axes in this control period are added on the basis of the moving command data, the interpolation data and current positions of the axes and determine whether or not the calculated distance is equal to or greater than an acceptable amount defined in advance; and
an alerting unit configured to output an alert in the case where the path displacement determining unit determines that the distance is equal to or greater than the acceptable amount defined in advance.
